(19) United States
(12) Patent Application Publication
(10) Pub. No.: US 2026/0220863 A1
(43) Pub. Date: Jul. 30, 2026

(54) VEHICLE SENSOR-BASED AVATAR GENERATION

(71) Applicant: Toyota Jidosha Kabushiki Kaisha, Toyota-shi Aichi-ken (JP)

(72) Inventor: Tyler La Monda, Fairfield, CA (US)

(73) Assignee: Toyota Jidosha Kabushiki Kaisha, Toyota-shi Aichi-ken (JP)

(21) Appl. No.: 19/038,998

(22) Filed: Jan. 28, 2025

(51) Int. Cl. G06T 13/40; G06T 15/20; G06T 19/20; G06V 10/62; G06V 10/77; G06V 10/82; G06V 20/20; G06V 20/59

(52) U.S. Cl. CPC G06T 13/40; G06T 15/205; G06T 19/20; G06V 10/62; G06V 10/7715; G06V 10/82; G06V 20/20; G06V 20/597; G06T 2210/36; G06T 2219/2024

(57) ABSTRACT

Systems, methods, and other embodiments described herein relate to generating in-vehicle digital avatars of a vehicle occupant based on vehicle sensor data. In one embodiment, a method includes extracting physical characteristics of an occupant of a vehicle from a vehicle-captured image of the occupant and rendering a base digital avatar of the occupant based on extracted physical characteristics of the occupant. The method also includes extracting a feature of an object in an external environment of the vehicle from a vehicle-captured image of the object. The method also includes rendering a presentation digital avatar in a likeness of the occupant by transferring the feature of the object onto the base digital avatar of the occupant and animating the presentation digital avatar on a display device of the vehicle.

### TECHNICAL FIELD

The subject matter described herein relates, in general, to in-vehicle occupant-based digital avatars and, more particularly, to rendering an in-vehicle occupant-based digital avatar based on vehicle sensor data.

### BACKGROUND

A human-machine interface (HMI) is a vehicle component through which a user interacts with the vehicle. Historically, occupants have interacted with vehicle systems via knobs, dials, switches, and the like. For example, to change the temperature of a heating system, an occupant may move a slider. To change a radio station, an occupant may spin a dial. To activate seat heating elements, a user may depress a button on the dashboard. Over time, HMIs have advanced technologically to a point where some of this functionality is controlled via a touch-sensitive display device. For example, through touch operations, an occupant may access a menu to alter various heating system settings, including temperature, zonal control, and the strength at which the system fans operate. Through the HMIs, occupants may control additional, more recently developed systems. For example, a user may interface with a navigational application that provides navigation assistance and may also interface with a communication application through which a user may make and receive phone calls, etc.

### SUMMARY

In one embodiment, example systems and methods relate to a manner of improving a human-machine interface by generating a virtual assistant that 1) is in a visual likeness of the occupant of the vehicle and 2) is customized based on vehicle-captured information about the surrounding environment of the vehicle.

In one embodiment, an avatar render system for generating an avatar based on vehicle sensor data is disclosed. The avatar render system includes one or more processors and a memory communicably coupled to the one or more processors. The memory stores instructions that, when executed by the one or more processors, cause the one or more processors to extract physical characteristics of an occupant of a vehicle from a vehicle-captured image of the occupant and render a base digital avatar of the occupant based on extracted physical characteristics of the occupant. The memory also stores instructions that, when executed by the one or more processors, cause the one or more processors to extract a feature of an object in an external environment of the vehicle from a vehicle-captured image of the object. The memory also stores instructions that, when executed by the processor, cause the processor to render a presentation digital avatar in a likeness of the occupant by transferring the feature of the object onto the base digital avatar of the occupant and animate the presentation digital avatar on a display device of the vehicle.

In one embodiment, a non-transitory computer-readable medium for generating an avatar based on vehicle sensor data and including instructions that, when executed by one or more processors, cause the one or more processors to perform one or more functions is disclosed. The instructions include instructions to extract physical characteristics of an occupant of a vehicle from a vehicle-captured image of the occupant and render a base digital avatar of the occupant based on extracted physical characteristics of the occupant. The instructions also store instructions that, when executed by the one or more processors, cause the one or more processors to extract a feature of an object in an external environment of the vehicle from a vehicle-captured image of the object. The instructions also store instructions that, when executed by the processor, cause the processor to render a presentation digital avatar in a likeness of the occupant by transferring the feature of the object onto the base digital avatar of the occupant and animate the presentation digital avatar on a display device of the vehicle.

In one embodiment, a method for generating a digital avatar based on vehicle sensor data is disclosed. In one embodiment, the method includes extracting physical characteristics of an occupant of a vehicle from a vehicle-captured image of the occupant and rendering a base digital avatar of the occupant based on extracted physical characteristics of the occupant. The method also includes extracting a feature of an object in an external environment of the vehicle from a vehicle-captured image of the object. The method also includes rendering a presentation digital avatar in a likeness of the occupant by transferring the feature of the object onto the base digital avatar of the occupant and animating the presentation digital avatar on a display device of the vehicle

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an avatar render system that is associated with generating a digital avatar based on vehicle sensor data according to an embodiment disclosed herein.

FIG. 3 illustrates one embodiment of the avatar render system of FIG. 2 in a cloud-computing environment according to an embodiment disclosed herein.

FIG. 4 illustrates a flowchart for one embodiment of a method that is associated with generating a digital avatar based on vehicle sensor data according to an embodiment disclosed herein.

FIGS. 5A and 5B illustrate an example of generating a base digital avatar according to an embodiment disclosed herein.

FIG. 6 illustrates a flowchart for one embodiment of a method that is associated with generating a presentation digital avatar by transferring an object onto a base digital avatar according to an embodiment disclosed herein.

FIG. 7 illustrates an example of generating a presentation digital avatar by transferring an object onto a base digital avatar according to an embodiment disclosed herein.

FIG. 8 illustrates a flowchart for one embodiment of a method that is associated with generating a presentation digital avatar by transferring a theme of an object onto a base digital avatar according to an embodiment disclosed herein.

FIG. 9 illustrates an example of generating a presentation digital avatar by transferring a theme of an object onto a base digital avatar according to an embodiment disclosed herein.

FIG. 10 illustrates one embodiment of a neural network-based avatar render system that generates a presentation digital avatar based on vehicle sensor data according to an embodiment disclosed herein.

### DETAILED DESCRIPTION

Systems, methods, and other embodiments associated with improving vehicle human-machine interfaces (HMIs) by rendering occupant-based avatars customized by vehicle-collected perception information are disclosed herein. As previously described, vehicle HMIs are becoming more and more advanced. For example, some HMIs are touch-sensitive, where user commands are received via a touch-sensitive infotainment display. Even further, HMIs may accept other command modalities. For example, a vehicle may include cameras that detect an occupant's physical gestures. As such, an occupant may control a vehicle through gesture commands. As yet another example, a vehicle may include a microphone to capture audio signals. Captured audio signals can be processed by a vehicle system and used to control other vehicle systems.

Some vehicles may include in-vehicle virtual assistants. For example, a cartoon character may be presented on the infotainment display and may provide guidance, instruction, and requested information to an occupant. For example, responsive to a request by the occupant to “turn off the heater,” the cartoon character could respond, “your request has been received; the heater is now turned off.” This adds an element to the HMI that is both engaging and entertaining. In this way, the cartoon character may be a virtual assistant to the occupants of the vehicle in performing certain tasks and/or providing the occupant with safety information and/or requested information about the vehicle and its surroundings. While particular reference has been made to specific virtual assistant operations, virtual assistants in vehicles may be able to perform any number of tasks and operations.

However, these virtual assistants may be generic and not user-specific. That is, a virtual assistant of this type may not be adaptable to the specific occupants of the vehicle or current motifs and styles. Given their static and generic nature, the information provided by these virtual assistants may be dismissed or ignored. Thus, the information and utility provided by these systems may not be appropriately considered by a vehicle occupant. In one case, this could increase the potential risk to an occupant if safety information is dismissed or ignored.

Moreover, these avatars are not generated in consideration of the vast amounts of information available from vehicle sensors. That is, a vehicle may include sensors that can capture a wealth of information from the surrounding environment. While this information is used for various purposes, including object detection, lane-keep assist, lane change warning, and other advanced driver assistance systems, the perception information collected may also be used to generate engaging, interactive, and customizable avatars.

Specifically, the avatar render system of the present specification transfers elements and/or themes detected by vehicle environment sensors to an in-vehicle occupant-based avatar. That is, the system generates an avatar using information collected from vehicle cabin sensors, such as images of one or more vehicle occupants, so that the avatar may look like one of the occupants.

The system also collects information from exterior vehicle sensors, such as outwardly-facing cameras that capture images of the environment and individuals/objects in the environment. After generating a base digital avatar in the likeness of the occupant, the system uses the information collected from the external sensors to modify the base digital avatar based on thematic elements and/or physical elements from an individual/object in the environment. For example, an occupant may instruct the system to modify the base digital avatar to incorporate elements of a movie poster for a Western movie that the occupant sees through their windshield. Specifically, a character in the movie poster may be garbed in western gear, including a cowboy hat. Based on this request, vehicle sensors may capture an image of the movie poster, identify defining visual characteristics of the poster, and apply those visual characteristics to the base digital avatar. In the specific example described above, the occupant-based avatar may be altered to have western gear and a cowboy hat.

The generation of the thematic avatar may include more than transferring visual thematic elements; it may include generating an audio theme and animating the avatar based on the identified theme. For example, a character in a Western movie may exhibit certain physical behaviors/traits and speak in a particular manner (e.g., with a particular parlance, accent, and vocabulary). By comparison, a character in a Victorian-era movie may exhibit other physical behaviors/traits and speak in a different manner (e.g., with a different parlance, accent, and vocabulary). In either of these examples, the avatar render system may identify those elements consistent with the visual theme of the object and apply those elements (e.g., auditory, movement, and other elements) to the occupant-based generated avatar.

As another example, the occupant may see a pedestrian wearing sunglasses and an orange shirt and want to know how they (i.e., the vehicle occupant) would look if they wore those same sunglasses and shirt. In this example, the occupant could instruct the avatar render system to modify the in-vehicle avatar to be wearing the sunglasses of the orange-shirted pedestrian as captured by the environment sensors. Upon receiving this instruction, the system would modify the avatar to include the sunglasses and shirt of the nearby pedestrian.

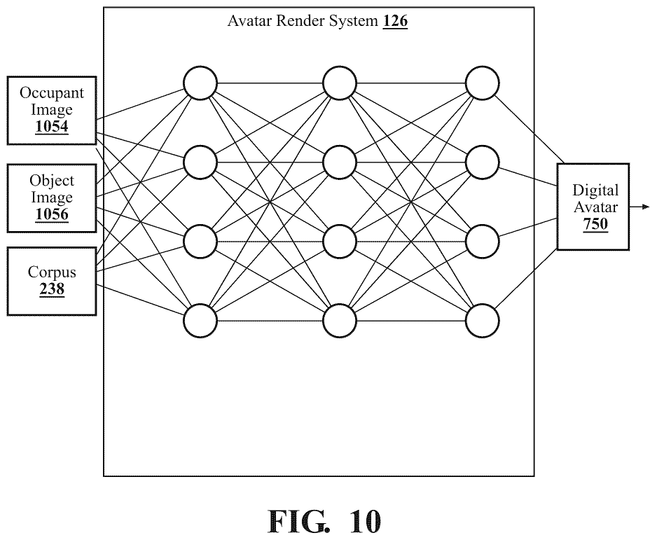

In an example, the avatar render system may incorporate a neural network or other machine-learning system. In general, a neural network is a computer architecture that is inspired by the structure of the human brain, having a network of interconnected nodes. Each node processes input data and produces an output using a mathematical operation. As depicted in FIG. 10, the nodes are arranged into layers, specifically, an input layer, a number of hidden layers, and an output layer. The input layer receives the images from a vehicle-captured image of an occupant, images of an object from which an element or theme is to be applied to the avatar, and a corpus of information that aids in identifying the feature and/or theme. Nodes in hidden layers perform computations and extract patterns from the input nodes. A node at the output layer produces the occupant-based avatar that incorporates features and/or elements of the object captured by the vehicle sensor. Such systems are particularly suited for handling large, complex data sets, including content available over the Internet.

In the context of the present specification, a generative neural network may create an avatar by creating new digital content, rather than replicating existing content, based on patterns identified in a large dataset, such as a corpus of digital content available from a curated dataset or an unsupervised dataset such as the internet. That is, the generative neural network-based avatar render system may be trained on a large dataset, which may be a specific curated dataset or an unsupervised dataset such as the internet. During training, the neural network-based avatar render system learns patterns in the dataset and uses such to generate new outputs (e.g., avatars) in response to an input (e.g., a vehicle-captured image and request by the occupant to apply a particular theme).

Accordingly, the avatar, while based on information collected from vehicle cabin sensors, may have a theme to create an entertaining and immersive experience. This enhances the capabilities of generative systems by introducing a new type of sensor information on which to base an avatar and may generate the avatar using on-road information collected during transit. The system is an improvement in that it enhances the technological capability by allowing users to modify an in-vehicle avatar using elements and/or themes detected by vehicle environment sensors. For example, the in-vehicle avatar could be modified to include clothing worn by a pedestrian that is detected by vehicle environment sensors while the vehicle is traveling. Accordingly, the avatar render system of the present specification describes an improvement by using new input forms (e.g., external vehicle sensor data) to generate an engaging in-cabin virtual assistant. While advanced driver assistance systems may use vehicle sensors to provide driver guidance, the present system uses vehicle sensors to generate in-cabin avatars. Thus, the present specification describes a system that integrates vehicle sensors with generative neural networks to generate specific, customized, and relevant in-vehicle digital assistants.

As the avatar is occupant-specific and customized by the occupant, the generated avatar may interact with the occupant in a more engaging way that is specific to the occupant, thereby increasing the likelihood of recognition and interaction with the virtual assistant. Moreover, the current system is an improvement as it incorporates real-time avatar customization while driving.

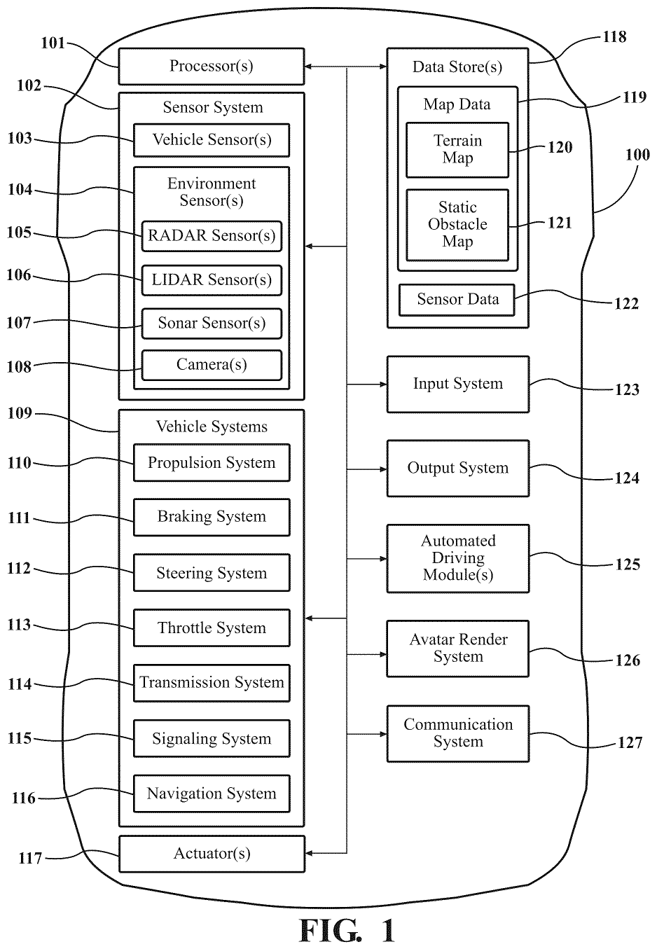

Turning now to the figures, FIG. 1 is an example of a vehicle 100. As used herein, a “vehicle” is any form of transport that may be motorized or otherwise powered. In one or more implementations, the vehicle 100 is an automobile. While arrangements will be described herein with respect to automobiles, it will be understood that embodiments are not limited to automobiles. In some implementations, the vehicle 100 may be a robotic device or a form of transport that, for example, includes sensors to perceive aspects of the surrounding environment, and thus benefits from the functionality discussed herein associated with generating avatars based on vehicle-collected sensor data.

The vehicle 100 also includes various elements. It will be understood that in various embodiments it may not be necessary for the vehicle 100 to have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

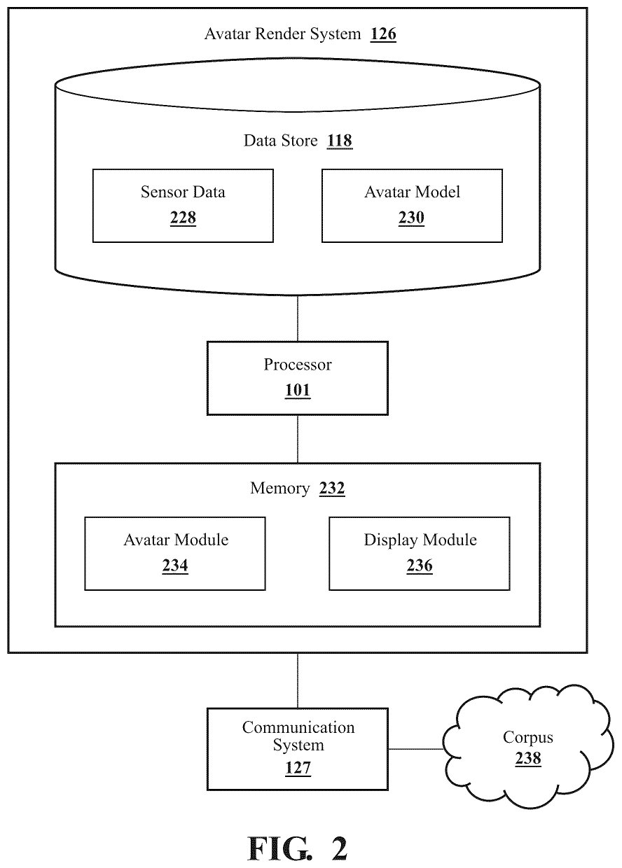

Some of the possible elements of the vehicle 100 are shown in FIG. 1 and will be described along with subsequent figures. However, a description of many of the elements in FIG. 1 will be provided after the discussion of FIGS. 2-10 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 100 includes an avatar render system 126 that is implemented to perform methods and other functions as disclosed herein relating to improving human-machine interfaces by incorporating bi-directional communication with an occupant-based avatar that incorporates elements captured by a driver of a vehicle while driving along a roadway.

As will be discussed in greater detail subsequently, the avatar render system 126, in various embodiments, is implemented partially within the vehicle 100, and as a cloud-based service. For example, in one approach, functionality associated with at least one module of the avatar render system 126 is implemented within the vehicle 100 while further functionality is implemented within a cloud-based computing system. Thus, the avatar render system 126 may include a local instance at the vehicle 100 and a remote instance that functions within the cloud-based environment.

Moreover, the avatar render system 126, as provided for within the vehicle 100, functions in cooperation with a communication system 127. In one embodiment, the communication system 127 communicates according to one or more communication standards. For example, the communication system 127 can include multiple different antennas/transceivers and/or other hardware elements for communicating at different frequencies and according to respective protocols. The communication system 127, in one arrangement, communicates via a communication protocol, such as a WiFi, dedicated short-range communications (DSRC), vehicle-to-infrastructure (V2I), vehicle-to-vehicle (V2V), or another suitable protocol for communicating between the vehicle 100 and other entities in the cloud environment. Moreover, the communication system 127, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the avatar render system 126 can leverage various wireless communication technologies to provide communications to other entities, such as members of the cloud-computing environment.

With reference to FIG. 2, one embodiment of the avatar render system 126 of FIG. 1 is further illustrated. The avatar render system 126 is shown as including a processor 101 from the vehicle 100 of FIG. 1. Accordingly, the processor 101 may be a part of the avatar render system 126, the avatar render system 126 may include a separate processor from the processor 101 of the vehicle 100, or the avatar render system 126 may access the processor 101 through a data bus or another communication path that is separate from the vehicle 100. In one embodiment, the avatar render system 126 includes a memory 232 that stores an avatar module 234 and a display module 236. The memory 232 is a random-access memory (RAM), read-only memory (ROM), a hard-disk drive, a flash memory, or another suitable memory for storing the modules 234 and 236. The modules 234 and 236 are, for example, computer-readable instructions that, when executed by the processor 101, cause the processor 101 to perform the various functions disclosed herein. In alternative arrangements, the modules 234 and 236 are independent elements from the memory 232 that are, for example, comprised of hardware elements. Thus, the modules 234 and 236 are alternatively application-specific integrated circuits (ASICs), hardware-based controllers, a composition of logic gates, or another hardware-based solution.

Moreover, in one embodiment, the avatar render system 126 includes the data store 118. The avatar render system 126 is shown as including a data store 118 from the vehicle 100 of FIG. 1. Accordingly, the data store 118 may be a part of the avatar render system 126, the avatar render system 126 may include a separate data store from the data store 118 of the vehicle 100, or the avatar render system 126 may access the data store 118 through a data bus or another communication path that is separate from the vehicle 100. The data store 118 is, in one embodiment, an electronic data structure stored in the memory 232 or another data storage device and that is configured with routines that can be executed by the processor 101 for analyzing stored data, providing stored data, organizing stored data, and so on. Thus, in one embodiment, the data store 118 stores data used by the modules 234 and 236 in executing various functions.

In one embodiment, the data store 118 stores sensor data 228. The sensor data 228 may be an example of the sensor data 122 depicted in FIG. 1. In general, the sensor data 228 is data provided from one or more sensors of the sensor system 102. Thus, the sensor data 228 may include observations of the surrounding environment of the vehicle 100 and/or observations of the interior environment of the vehicle 100. For example, the vehicle 100 may be equipped with in-cabin cameras that capture images of the occupants in the vehicle 100. The sensor data 228 may include the output (i.e., images) of these cameras. These camera images may be the foundation on which an occupant-based digital avatar is rendered.

As described below, the vehicle occupant may direct the avatar render system 126 to apply a particular element or theme from an object in the surrounding environment to the generated avatar. Such a command may come in various forms, including gestural and audible commands. In the case of a gestural command, the in-cabin cameras of the vehicle 100 may capture images of the occupant such that gestural commands may be detected. The vehicle 100 may also include in-cabin microphones to capture audio signals from which a vocal command may be extracted. In both cases, the output of these in-cabin sensors may be included in the sensor data 228.

Still further, the vehicle 100 may include outward-facing cameras 108 that capture images of the environment surrounding the vehicle 100 and objects in the environment. As described below, the avatar render system 126 may process these images to 1) identify objects in the images, including those objects specifically targeted by a vehicle occupant and 2) identify elements of the objects and/or thematic features of the objects. Accordingly, the sensor data 228 may include the output of these outwardly-facing cameras as well.

In one embodiment, the data store 118 stores the sensor data 228 along with, for example, metadata that characterizes various aspects of the sensor data 228. For example, the metadata can include location coordinates (e.g., longitude and latitude), relative map coordinates or tile identifiers, time/date stamps from when the separate sensor data 228 was generated, and so on.

In one embodiment, the data store 118 further includes an avatar model 230, which may be relied on by the avatar module 234 to generate the digital avatars. In an example, the avatar render system 126 may be a generative neural network-based system that generates the presentation digital avatar based on identified patterns in a corpus of digital images (e.g., digital content available on the internet). In the context of the present application, a generative neural network-based avatar render system 126 relies on some form of generative machine learning, whether supervised, unsupervised, reinforcement, or any other type, to identify physical elements of an object or to identify a theme of the visual characteristics of the object based on the vehicle-captured images. The avatar render system 126 transfers those elements or themes onto a base digital avatar of the occupant of the vehicle. In any case, the avatar model 230 includes the weights (including trainable and non-trainable), biases, variables, activation functions, rules, algorithms, parameters, and other elements that operate to output an occupant-specific and customized digital avatar based on vehicle-captured images of the surrounding environment. Additional details regarding the operation of a neural network-based avatar generation system 126 are provided below in connection with FIG. 10.

The avatar render system 126 includes an avatar module 234. In general, the avatar render system 126 converts an image of an occupant into a digital avatar. This may include transforming the features of the occupant into a stylized version, in some examples, by incorporating thematic elements or physical elements identified in the surrounding environment of the vehicle 100. The avatar module 234 may process captured images and deploy a neural network to alter a base digital avatar based on designated inputs to generate a presentation digital avatar. The avatar module 234 then transmits the presentation digital avatar to a display module 236, that generates the presentation digital avatar on the display device of the vehicle 100.

As described in more detail below, the avatar render system 126, and more particularly the avatar module 234, may be a neural network-based system that creates new digital content, such as a digital avatar, based on identified patterns learned from a large dataset. In this example, the avatar module 234 may, via the communication system 127, access a corpus 238 of digital content. In one example, the corpus 238 may be the internet and all information accessible therein. The corpus 238 may include data from retail websites, video-hosting applications, images, social media platforms, and other sources. Accordingly, the avatar module 234 may access the corpus 238 to aid in identifying a physical element of an object or a thematic element of the object to be incorporated into the digital avatar as described below. While particular reference is made to a particular corpus 238 (e.g., the internet), the corpus 238 may include other datasets, such as a structured dataset of images tagged with metadata indicating the objects' thematic and or physical features.

The avatar module 234 may include instructions that cause the processor 101 to extract the physical characteristics of an occupant of a vehicle 100 from a vehicle-captured image of the occupant. That is, the presentation digital avatar that is ultimately generated may have a likeness of the occupant. Accordingly, the avatar module 234 may capture images of the occupant and analyze the images to extract characteristic features of the occupant that will be translated into a digital form as a base digital avatar. For example, each occupant has distinguishing facial features. Examples include eye position, eye shape, nose position, nose shape, mouth position, mouth shape, cheek lines, hairline, jawline, and facial structure, among other characteristic features. While particular references are made to particular features, the avatar module 234 may identify other occupant characteristics. Moreover, while particular references are made to facial features, in some examples, the avatar module 234 may extract other features of the occupant. For example, the avatar module 234 may extract hair length, hair color, hairstyle, shoulder width, etc., for the user.

In any case, the avatar module 234 may include a processor that identifies these characteristics of an occupant from images captured by an in-vehicle camera of the vehicle 100. In an example, feature identification may be based on an analysis of the pixels and the color values thereof that make up the image. In addition to identifying the features in an image, the avatar module 234 may be able to localize the features. For example, the avatar module 234 may determine the relative distance between different detected features. As such, the avatar module 234 generates a map of the occupant's face based on detected facial features and the relative and absolute position of those features.

In an example, the avatar module 234 may extract the features from multiple images, which images may capture different perspectives of the occupant, for example, as the occupant rotates/turns their head during the operation of vehicle 100. For example, it may be that the digital avatar is a three-dimensional avatar viewable from multiple angles (i.e., by animating the digital avatar). In this example, a single image may not include sufficient information to generate the 3D model. Accordingly, in this example, the avatar module 234 may extract the features from multiple images to establish a three-dimensional representation of the occupant.

In one particular example, the avatar module 234 may deploy a machine-learning or neural network-based system to extract these characteristic features of the user. For example, a machine-learning system may detect, identify, and map facial features such as the eye, nose, mouth, and face shape.

The avatar module 234 also includes instructions that cause the processor 101 to render a base digital avatar of the occupant based on extracted physical characteristics of the occupant. In general, a digital avatar may be a digital representation of the occupant, for example, that has similar features (e.g., eye position, eye shape, nose position, nose shape, mouth position, mouth shape, cheek lines, hairlines, jawline, facial structure, etc.) as the occupant. Accordingly, the avatar module 234 may use the extracted features to generate a digital caricature of the vehicle's occupant.

In some examples, the base digital avatar is an alterable, multi-perspective digital representation of the occupant. That is, the base digital avatar may be moved, rotated, or otherwise manipulated and displayed from different angles. For example, the head of the digital model may be animated to look up and to the right. Therefore, The base digital avatar is not merely a static replication of an input image but a complete three-dimensional representation of the occupant, such that the display module 236 can present the base digital avatar as viewable from different angles. As described above, a single vehicle-captured image may not provide sufficient detail of all angles of the occupant to generate a multi-perspective model of the occupant. Accordingly, the avatar module 234 may combine multiple images taken from different perspectives and captured during the occupant's operation of the vehicle 100 to generate a three-dimensional avatar. In other words, the base digital avatar may be a three-dimensional representation of the occupant generated from multiple two-dimensional images.

The avatar module 234 includes instructions that cause the processor 101 to extract a feature of an object in an external environment of the vehicle 100 from a vehicle-captured image of an object. As described above, an occupant of the vehicle 100 may want to incorporate the features of an object in the environment onto their in-vehicle digital avatar. Previously, an occupant of a vehicle 100 may not have any means, while driving or in a moving vehicle, to capture an image of an object and transfer the features of the object to their digital avatar while in a moving vehicle 100. The present avatar render system 126 facilitates this by relying on exterior vehicle sensors to identify and capture an image of the object, extract features of that object, and apply such to the in-vehicle digital avatar for the occupant, all while the vehicle 100 is in motion or otherwise on a roadway.

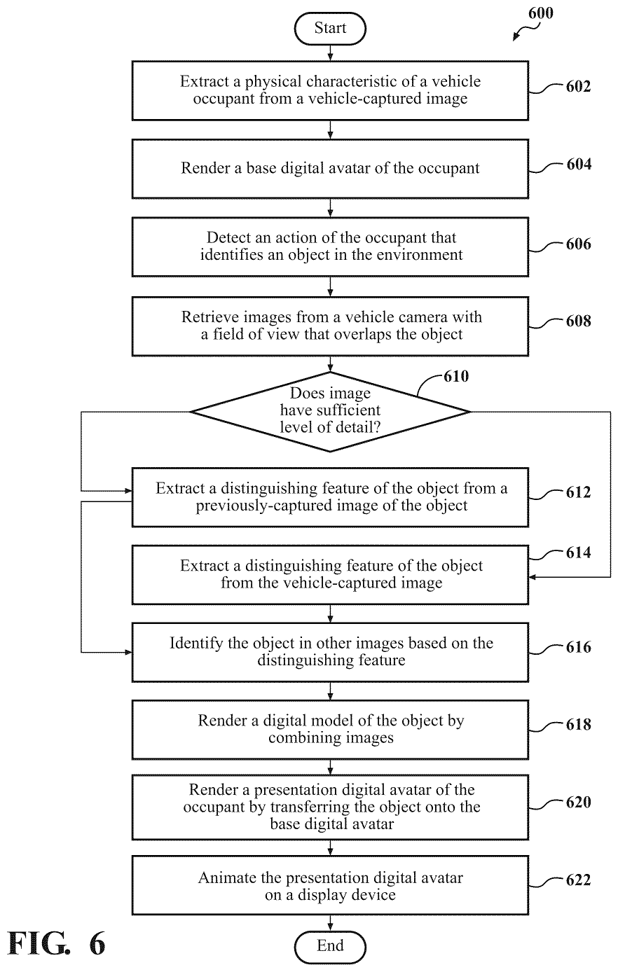

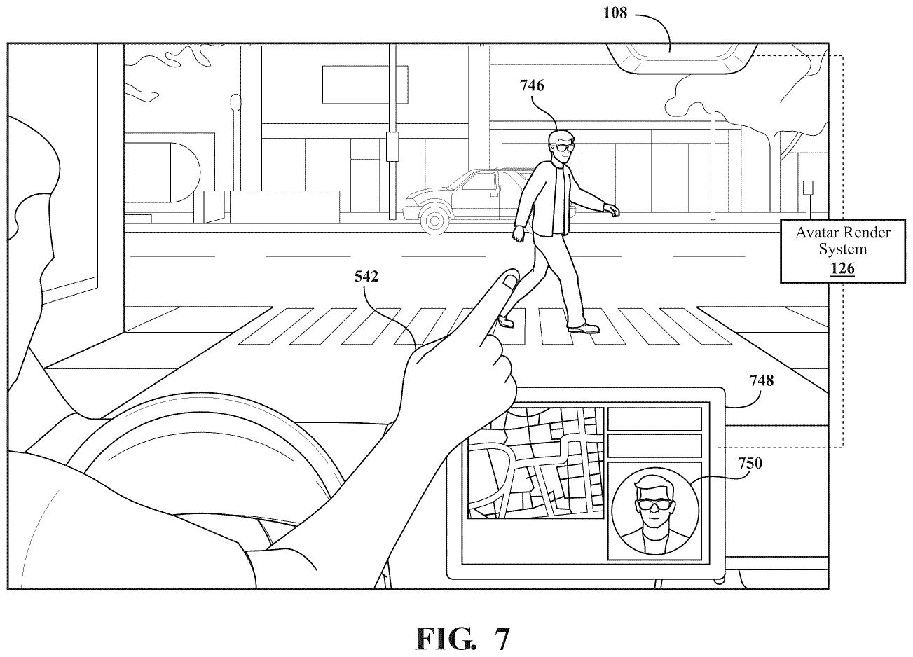

In an example, the extracted feature is the physical structure of the object. For example, a driver of the vehicle 100 may see clothing items in a store window or worn by a pedestrian. The driver may desire to see what they (i.e., the driver) would look like, adorned with the clothing in the store window or worn by the pedestrian. Accordingly, the avatar module 234 may identify the object, generate a digital representation of that object, and transpose the object on the base digital avatar of the occupant to generate a presentation digital avatar that incorporates the clothing items. Additional details regarding the identification of an object and extraction of the physical structure feature of the object are described below in connection with FIGS. 6 and 7.

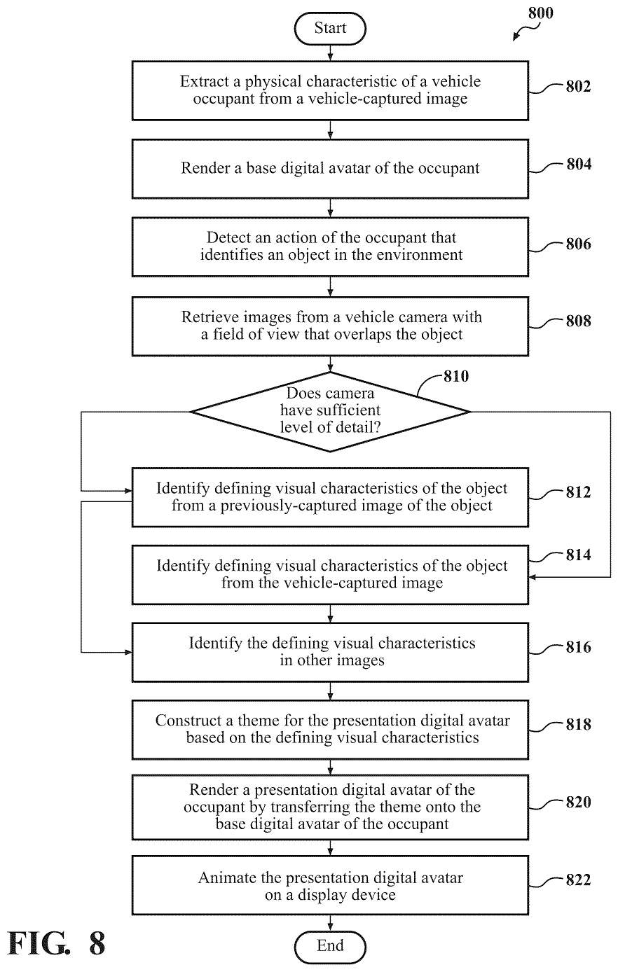

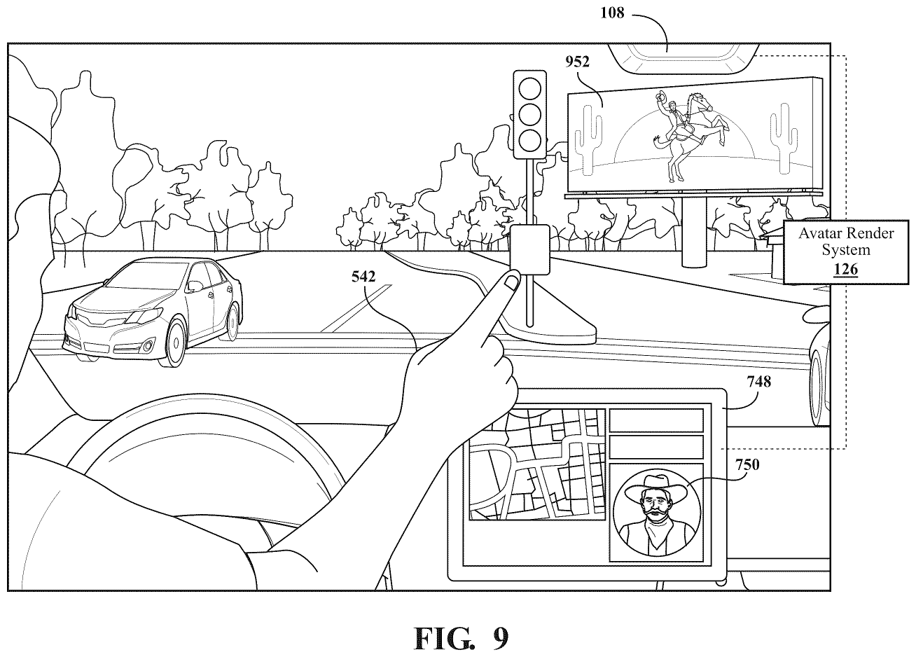

In another example, the feature is a visual element of the object. For example, while driving along a road, a passenger may see a movie poster for a time-period movie set in the Victorian era. This movie poster may have distinguishing visual characteristics, such as a particular color palette, color grading, lighting effect, texture, composition, and/or motif, among other visual characteristics. In this example, the avatar module 234 may identify and extract these and other visual characteristics from the object to generate a theme, the theme being defined by the various visual characteristics. The avatar module 234 may then apply the theme (i.e., the distinguishing visual characteristics from the object) to the base digital avatar, thus generating a presentation avatar based on real-time information collected as a vehicle 100 traverses a roadway. Additional details regarding the identification of a theme of an object and the application of such to a base digital avatar of the occupant to generate a presentation digital avatar of the occupant are described below in connection with FIGS. 8 and 9.

Note that the avatar module 234 may deploy a neural network in either of these examples. That is, as described below in connection with FIG. 10, the avatar module 234, in addition to relying on extracted features from the object itself, may identify additional digital content from the corpus 238 that has similar visual characteristics as the object. The avatar module 234 may apply visual characteristics from 1) the object (as extracted from the vehicle-captured image) and 2) the additional digital content to the base digital avatar to generate the presentation digital avatar.

In either case, the avatar module 234 includes instructions that cause the processor 101 to render a presentation digital avatar in a likeness of the occupant by transferring the feature of the object (whether the feature is a physical structure of the object or a thematic element of the object) onto a base digital avatar of the occupant.

Again, this may be implemented in a neural network. For example, a deep learning model such as a generative adversarial network (GAN) can apply a thematic effect to the digital model to create an avatar. As described above, a neural network may be trained on data, such as text, audio, or images, and patterns and structures may be identified in the data. In the context of the present application, the GAN may be trained on a dataset that contains hundreds of thousands of tagged images (i.e., a supervised learning of a curated dataset) or untagged images (i.e., unsupervised learning of an unregulated dataset such as the internet). The neural network may employ gradient descent to adjust internal parameters to enhance the network's ability to identify parameters and employ specific visual characteristics of the object.

While the avatar module 234 is discussed as controlling the various sensors to provide the sensor data 228, in one or more embodiments, the avatar module 234 can employ other techniques to acquire the sensor data 228 that are either active or passive. For example, the avatar module 234 may passively sniff the sensor data 228 from a stream of electronic information provided by the various sensors to further components within the vehicle 100.

It should be appreciated that the avatar module 234 in combination with the avatar model 230 can form a computational model such as a neural network model. In any case, the avatar module 234, when implemented with a neural network model or another model, in one embodiment, implements functional aspects of the avatar model 230 while further aspects, such as learned weights, may be stored within the data store 118. Accordingly, the avatar model 230 is generally integrated with the avatar module 234 as a cohesive, functional structure.

The avatar render system 126 also includes a display module 236, which includes instructions that cause the processor 101 to animate the presentation digital avatar on a display device of the vehicle 100. For example, the display module 236 may animate a mouth of the presentation digital avatar to align with output audio. While particular references are made to a particular animation, the display module 236 may animate the presentation of the digital avatar in a variety of ways. Yet again, the avatar render system 126 may employ a neural network with a pretrained model that transforms the presentation digital avatar to appear animated.

As such, the avatar render system 126 of the present specification generates a digital avatar that not only has a likeness to match the occupant but also incorporates features of environmental objects captured by a moving vehicle 100 into the avatar, such as physical structures of objects (e.g., articles of clothing) and thematic elements (e.g., color schemes, composition schemes, etc.).

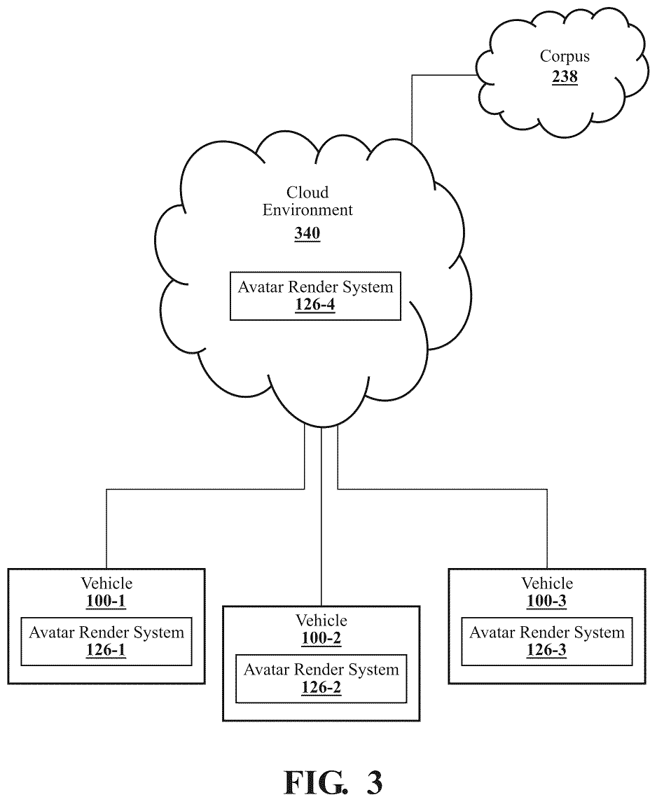

In an example, the avatar render system 126, as illustrated in FIG. 2 may be implemented in a vehicle 100 as depicted in FIG. 1 or in a cloud environment 340 as depicted in FIG. 3. As illustrated in FIG. 3, the avatar render system 126 is embodied at least in part within the cloud environment 340. That is, as described above, the avatar render system 126, in various embodiments, is implemented partially within the vehicle 100, and as a cloud-based service. For example, in one approach, at least some functionality associated with at least one module of the avatar render system 126 is implemented within the vehicle 100 while further functionality is implemented within a cloud environment 340. For example, each vehicle 100-1, 100-2, and 100-3 may include respective instances of the avatar render system 126-1, 126-2, and 126-3, each capturing images of the respective occupants and surrounding environment. In one particular example, vehicle-based instances of the avatar render system 126-1, 126-2, and 126-3 may also perform some image processing, such as identifying features in the images and animating the presentation of digital avatars upon reception from the cloud environment-based instance of the avatar render system 126-4. In either example, the cloud environment-based instance of the avatar render system 126-4 may perform the other operations described herein, such as neural network-based object identification and/or theme generation. For example, the cloud environment-based instance of the avatar render system 126-4 may interact with the corpus 238 of digital content to identify other images of the object with similar physical structures or images of other objects with a similar theme as the vehicle-captured object.

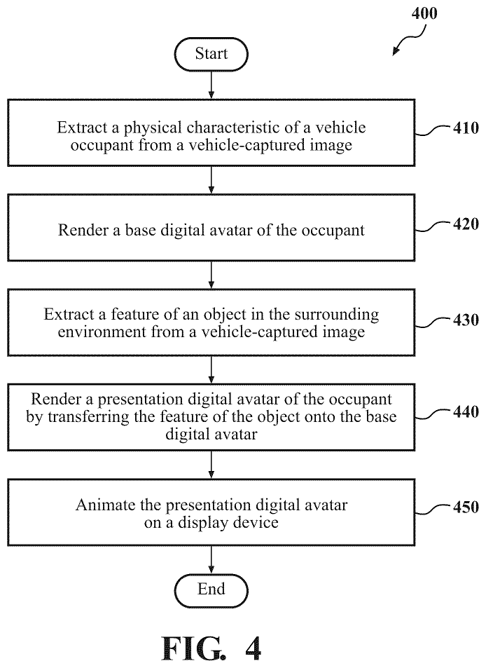

Additional aspects of generating vehicle sensor-based occupant-specific digital avatars will be discussed in relation to FIG. 4. FIG. 4 illustrates a flowchart of a method 400 that is associated with generating in-vehicle occupant avatars based on vehicle sensor captured data. Method 400 will be discussed from the perspective of the avatar render system 126 of FIGS. 1, 2, and 3. While method 400 is discussed in combination with the avatar render system 126, it should be appreciated that the method 400 is not limited to being implemented within the avatar render system 126 but is instead one example of a system that may implement the method 400.

At 410, the avatar render system 126 extracts physical characteristics of an occupant of the vehicle 100 from a vehicle-captured image of the occupant. That is, as described above, an occupant-facing camera mounted on an interior space of the vehicle 100 may capture images or a video stream of the occupant. The avatar module 234 may include a processor 101 that can detect objects within the image, such as facial or other physical features of the occupant, and localize the features. Accordingly, at 410, the avatar module 234 extracts the features and identifies the relative position of different features of the occupant within the image. This information is later relied on when generating a base digital avatar in the likeness of the occupant.

At 420, the avatar module 234 renders a base digital avatar of the occupant based on extracted physical characteristics of the occupant. That is, the avatar module 234 may construct a representation of the occupant based on the extracted facial features (e.g., facial feature shapes, tones, sizes, etc.). Specifically, the avatar module 234 may arrange the pixels that define a base digital avatar to be consistent with the detected facial features of the occupant as captured by the in-vehicle camera.

At 430, the avatar module 234 extracts a feature of an object in an external environment of the vehicle 100. That is, it may be that an occupant of the vehicle 100 desires to incorporate observed objects in the real world into their personalized digital avatar. As a specific example, an occupant may desire to incorporate the physical structure of a real-world object onto their avatar. As another example, an occupant may desire to incorporate the visual characteristics of an object, such as a real-world movie poster or a pedestrian, onto their avatar. In either case, after identifying a target object, the avatar module 234 may extract the features of the target object, whether the features are distinguishing features of the object such that a digital representation of the object may be identified in a corpus 238 of digital content or thematic features of the object such that the theme may be applied to the digital avatar. Specifically, the avatar module 234 may analyze the pixels that make up to the image to identify the structure and/or visual characteristics of the object.

At 440, the avatar module 234 may render a presentation digital avatar of the occupant by transferring the feature of the object (e.g., the physical structure of the object or thematic feature of the object) onto the base digital avatar. Specifically, the avatar module 234 can alter the pixel configuration of the base digital avatar to incorporate a digital representation of an object or to include the thematic elements of the object.

At 450, the avatar render system 126, and more specifically, the display module 236 animates the presentation digital avatar on a display device of the vehicle 100. That is, to make the presentation digital avatar more engaging, the presentation digital avatar may be animated to move. For example, while giving instruction, the display module 236 may animate the mouth of the presentation digital avatar to coincide with the words of the instruction. In another example, the display module 236 may animate an appendage of the presentation digital avatar or move the head of the presentation digital avatar to direct the attention of the occupant to a particular region of the infotainment display. While particular reference is made to particular animations, the presentation digital avatar may be animated in any number of fashions as desired to communicate with the occupants of the vehicle 100.

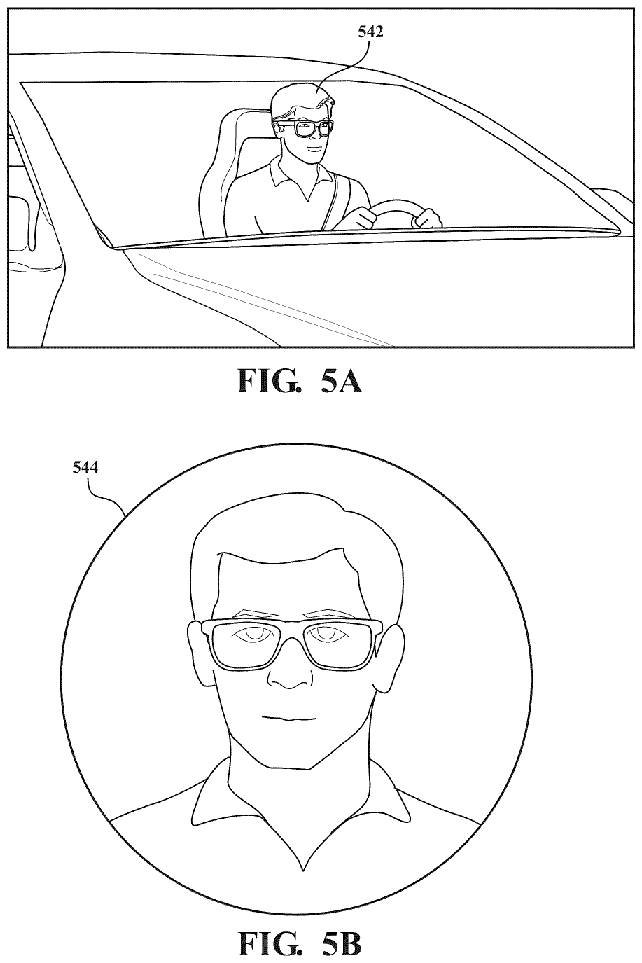

FIGS. 5A and 5B illustrate an example of generating an occupant-based base digital avatar 544 according to an embodiment disclosed herein. Specifically, FIG. 5A depicts a captured image of an occupant 542 of a vehicle 100, and FIG. 5B depicts the base digital avatar 544 that is a likeness of the occupant 542, and that is based on vehicle-captured information. That is, as described above, the vehicle 100 may include a camera that captures in-cabin images of occupants 542 of the vehicle 100.

As depicted in FIG. 5A, the image of the occupant 542 may be two-dimensional and may not supply occupant characteristic data about certain portions of the occupant 542, such as the rear of the occupant's head and or parts of the occupant's body that are occluded. In the example depicted in FIG. 5A, a portion of the occupant's torso is obscured by an outstretched arm of the occupant 542. Accordingly, when generating the base digital avatar 544 depicted in FIG. 5B, the avatar module 234 may capture multiple images of the occupant 542, such that features of the occupant 542 that are obscured or otherwise not visible in one image may be accounted for in other captured images of the occupant 542.

As described above, an image processor of the avatar module 234, which may be a neural network-based processor, analyzes the image captured by the in-cabin camera and identifies and localizes certain features that are characteristic of the occupant 542. Such features include facial features such as facial structure and characteristics of key features of the face such as the eyes, nose, mouth, and ears. Example characteristics include the size of the feature, the shape of the feature, a tone of the feature. While particular reference is made to particular features of the occupant 542 that are extracted from the image to define the occupant 542, the avatar module 234 may extract other features from the vehicle-captured image of the occupant 542.

As depicted in FIG. 5B, the avatar module 234 may generate a base digital avatar 544 of the occupant 542. The base digital avatar 544 may be a likeness of the occupant 542, meaning that the base digital avatar 544 is rendered to exhibit the same characteristics and features of the occupant 542 as extracted from the vehicle-captured image of the occupant 542. That is, the base digital avatar 544 may have the same facial structure and key feature characteristics as the occupant 542, albeit stylized by altering coloration, line thickness, etc. of features of the base digital avatar 544, while maintaining the physical characteristics of the occupant 542.

FIG. 6 illustrates a flowchart for one embodiment of a method 600 that is associated with generating an occupant-based avatar by transferring an object onto the avatar according to an embodiment disclosed herein. Reference may be made to FIG. 7, which depicts a scenario where the method 600 may be executed.

As described above, the avatar render system 126 applies, transposes, or otherwise transfers objects detected by vehicle sensors, such as an outwardly-facing camera 108, onto an occupant-based base digital avatar 544. As a result, a user-customized presentation digital avatar 750 may be presented on the display device 748 of the vehicle 100. In the example depicted in FIGS. 6 and 7, the feature that is transferred is the physical structure of the object. Specifically, the object, as depicted in FIG. 7 are the sunglasses and jacket worn by a pedestrian 746 detected in the environment.

At 602, as depicted and described in connection with FIG. 5A, the avatar module 234 extracts a physical characteristic of a vehicle occupant 542 from a vehicle-captured image, and at 604, the avatar module 234 renders a base digital avatar 544 of the occupant 542. The remaining operations of the method 600 describe how a feature of an environmental object is transposed on the base digital avatar 544 to generate the presentation digital avatar 750. First, the avatar render system 126 may identify the target object whose feature (in this example, the physical structure of the object) is to be transposed. Accordingly, at 606 the avatar render system 126 may detect an action of the occupant 542 that identifies an object in the environment. That is, the avatar render system 126 includes instructions that cause the processor 101 to detect an action of the occupant 542 that identifies the object and a location of the object. The action may take a variety of forms.

For example, as depicted in FIG. 7, the occupant 542 may point at an object. In this example, the occupant 542 points to a pedestrian 746 crossing in front of the vehicle 100. In another example, the occupant 542 may audibly identify the object. For example, the occupant 542 may state, “update my avatar to include the sunglasses and jacket worn by the man crossing the street in front of me.” As described above, the vehicle 100 may include various sensors, including in-cabin cameras, that may capture the gesture and identify a target of the gesture (e.g., a location where the occupant 542 is pointing). In an example, the vehicle 100 may analyze the gaze direction/head pose of the occupant 542 to identify the target object. Still further, the vehicle 100 may also include a microphone to capture an audible command. A processor 101 of the avatar render system 126 may analyze any one or multiple of these inputs (e.g., audio command, body gesture, head/gaze direction) to identify the target object and the location of the target object. Specifically, the avatar render system 126 may identify the location of the target object, in part by identifying a gesture direction, head/eye gaze direction, or other location around the vehicle 100 where the object is located.

At 608, the avatar render system 126 retrieves images captured by a vehicle camera with a field of view that overlaps the location of the object. That is, by analyzing the user action, the avatar render system 126 may be able to identify a sensor with a field of view that captures the object. For example, the avatar render system 126 may determine that the occupant 542 is gazing/gesturing towards the front of the vehicle 100. Accordingly, the avatar render system 126 may retrieve images from an outward-facing camera 108 at the front of the vehicle 100. That is, the system may receive the vehicle-captured image of the object from a vehicle camera.

In some examples, it may be that a captured image has low resolution, is blocked, or, for a variety of other reasons, has insufficient resolution to extract identifying features of the object. That is, in attempting to extract features, the image processor may include any number of thresholds by which it may determine that the identifying features of an object cannot be accurately extracted from the images. Accordingly, at 610, the avatar module 234 may determine the level of detail of the feature of the object in the vehicle-captured image and determine if the image has a sufficient level of detail, based on predetermined threshold metrics, to extract features of the object. Responsive to the level of detail being greater than a threshold amount, at 614 the avatar module 234 extracts a distinguishing feature of the object from the vehicle-captured image. In this example, the avatar module 234 may access the output of a different exterior camera to identify an image of the object with detail greater than the threshold amount.

Responsive to the level of detail being less than the threshold amount, the avatar module 234 may identify a previously captured image of the object from a log of vehicle-captured images. That is, the sensor data 228 described above may include a history of collected images from the outward-facing camera 108. Accordingly, once the target object is identified in a current image, the avatar render module 234 may process other images in the log to determine if the target object is identified in any other images. This may be done based on a lower-resolution identification of the object. For example, it may be that an image is not clear enough to characterize an object for rendering into an avatar but may be clear enough to facilitate identification of the object in other images. In either case, at 612 and 614, the avatar module 234 may extract the distinguishing feature of the object from either a current vehicle-captured image or a previously-captured vehicle-captured image of the object.

As described above, the digital model of the object may be reproduced based on a combination of multiple images of the object. That is, it may be challenging to generate a complete digital model of an object based on a single vehicle-captured image or even multiple vehicle-captured images. Accordingly, the avatar render system 126 may, in some examples using a neural network, acquire additional data points to serve as source guides for rendering the digital model of the object. Specifically, the avatar module 234 may operate to, at 616, identify the object in other images of the corpus 238 of digital content. This may be done based on a distinguishing feature of the object. That is, each object may have certain characteristics that differentiate it from other objects. Examples of distinguishing characteristics include logos, patterns, colors, etc. For example, the sunglasses worn by the pedestrian 746 may include a logo of the manufacturer. Moreover, the jacket worn by the pedestrian 746 may include distinct features such as lapel shapes, colors, etc. While particular reference is made to particular distinguishing features, the avatar module 234 may extract other distinguishing features, such as the shape, color, material, etc., of the object. The avatar module 234 may extract these and other distinguishing features from the vehicle-captured image. Then, the avatar module 234 may identify the object in other images based on the distinguishing feature. That is, the avatar module 234 may scour other images in the corpus 238 to identify the distinguishing features in different images.

In either case, at 618, the avatar module 234 may render a digital model of the object by combining the vehicle-captured image of the object with other images of the object. That is, the avatar module 234, in some examples deploying a neural network, can identify patterns in images of the object and can rely on these patterns to generate a digital representation of the object.

In some cases however, the plurality of images that serve as the basis of the digital model may not include a view of the object from every angle, or the lighting of the images may be different than the lighting intended for the presentation digital avatar 750. That is to say, the combination of multiple images may yet result in a digital representation that is incomplete. In this example, the neural network avatar module 234 may infer features of the object that are omitted from the vehicle-captured image of the object and the other images of the object. For example, it may be that images of a jacket worn by the pedestrian 746 do not include details regarding the underarm space of the jacket. In this example, a generative neural network avatar module 234 may fill in details in this region of the jacket to render a three-dimensional representation of the jacket. As another example, the avatar module 234 may alter the lighting of the jacket to reflect a lighting for the environment of the presentation digital avatar 750.

At 620, the avatar module 234 may render a presentation digital avatar 750 of the occupant 542 by transferring the object onto the base digital avatar 544 of the occupant 542. For example, the avatar module 234 may transfer the sunglasses and the jacket onto the base digital avatar 544 of the occupant 542 to generate a presentation digital avatar 750 of the occupant. Specifically, the avatar module 234 may alter the pixels that define the base digital avatar 544 so that they are consistent with the pixels of the digital model of the object.

At 622 and as described above, the display module 236 may animate the presentation digital avatar 750, with the objects transposed thereon, on the display device 748 of the vehicle 100. Accordingly, the present avatar render system 126 provides a user-based customized presentation digital avatar 750 that is uniquely generated based on vehicle-sensor captured data, thereby enabling the real-time incorporation of environmental elements in a moving environment onto an in-vehicle avatar.

FIG. 8 illustrates a flowchart for one embodiment of a method 800 that is associated with generating an occupant-based avatar by transferring an object theme onto a base digital avatar 544 according to an embodiment disclosed herein. Reference may be made to FIG. 9, which depicts a scenario where the method 800 may be executed.

As described above, the avatar render system 126 applies, transposes, or otherwise transfers objects detected by vehicle sensors, such as an outwardly-facing camera 108, onto an occupant-based base digital avatar 544. As a result, a user-customized presentation digital avatar 750 may be presented on the display device 748 of the vehicle 100. In the example depicted in FIGS. 8 and 9, the feature that is transferred is the thematic feature of the object, which is a movie poster 952. While particular reference is made to a movie poster 952 object, the object may be of various types, including an individual, a video stream, a billboard, or any other physical object with distinguishing visual characteristics. That is to say, an image or may have certain visual characteristics that give the image a distinctive aesthetic and tone. Examples of thematic characteristics include a subject matter, a color palette, a color scheme (including shades, hues, tones, and contrast), a composition or arrangement of elements within the image, shapes in the image, lighting (including a quality, direction, and intensity of the light) of the image, a lighting effect (e.g., natural light, artificial light, shadows, and highlights), a texture (e.g., photographic texture, material textures, or brush strokes), a style (e.g., cartoon, anime, realist, surrealist, vintage, modern, etc.), a perspective, a tonal range, contrast, filters, a framing, a layout, a spacing, and a typography. While particular references are made to particular visual characteristics, an image or object may include a variety of visual characteristics that may contribute to a theme for the image or object. In this example, the avatar module 234, using a neural network, may identify these visual characteristics of the object and other similar objects to define a theme to be applied to the base digital avatar 544.

At 802, as depicted and described in connection with FIG. 5A, the avatar module 234 extracts a physical characteristic of a vehicle occupant 542 from a vehicle-captured image, and at 804, the avatar module 234 renders a base digital avatar 544 of the occupant 542. The remaining operations of the method 800 describe how a feature of an environmental object is transposed on the base digital avatar 544.

As described above, at 806 the avatar render system 126 may detect an action of the occupant 542 that identifies an object in the environment. At 808, the avatar render system 126 retrieves images from a vehicle camera with a field of view that overlaps the location of the object.

As described above, it may be that a captured image has low resolution, is blocked, or, for a variety of other reasons, has insufficient resolution to extract identifying features of the object. Accordingly, at 810, the avatar module 234 may determine if the image has a sufficient level of detail, based on predetermined threshold metrics, to extract features of the object. Responsive to the level of detail being greater than a threshold amount, at 814 the avatar module 234 extracts defining visual characteristics (e.g., those that contribute to a theme for the object) of the object from the vehicle-captured image. Responsive to the level of detail being less than the threshold amount, at 812, the avatar module 234 may identify, from a log of vehicle-captured images, a previously captured image of the object and extract the defining visual characteristics of the object from the previously captured vehicle-captured images.

In an example, the theme may be more fully constructed by considering additional images that include similar visual characteristics. That is to say, the object itself (e.g., the movie poster 952 itself) may have visual characteristics consistent with a particular theme, but there may be other visual characteristics that are also consistent with the particular theme. Accordingly, at 816, the avatar module 234 may identify the defining visual characteristics of other images. Specifically, the avatar module 234 may scour the corpus 238 to identify similar instances of the object (e.g., the movie poster 952) or other images in the corpus 238 that have the same or similar defining visual characteristics as the object. For example, the avatar module 234 may look for other images that include the movie poster 952, or other images/screenshots of the movie, or other promotional materials. That is, the corpus 238 may contain additional instances of the object or may include images of other objects that are visually similar to the object as determined by comparing the defining visual characteristics of the corpus 238 images to that of the recently vehicle-captured image of the object. Note that in analyzing the images of the corpus 238, the avatar module 234 may not only identify those images/objects with the same visual characteristics but may identify those with similar visual characteristics, with the similarity being measured by a predetermined threshold. For example, an image in the corpus 238 may have a similar, but not exactly the same, subject matter, color palette, color scheme, composition, lighting, texture, style, tonal range, contrast, and/or layout, but not an exact match. This image may be paired with the vehicle-captured image pertaining to the same theme based on any predetermined similarity criteria, which similarity criteria may be machine-learned and/or based on feedback from a user.

In either example, at 818 the avatar module 234 may construct a theme for the presentation digital avatar 750 based on the defining visual characteristic of the object. Specifically, the avatar module 234 may deploy a neural network that identifies patterns in the visual characteristics of the object and the visual characteristics in the vast repository of digital content in the corpus 238 to construct the theme associated with the object.

The avatar module 234 may aggregate the defining visual characteristics of the object and the other images to construct the theme. For example, the avatar module 234 may weigh the different visual characteristics in constructing the theme. In any case, at 820, the avatar module 234 may render a presentation digital avatar 750 of the occupant 542 by transferring the visual features defined by the theme onto the base digital avatar 544 of the occupant 542. Note again that in applying the visual characteristics, the avatar module 234 may apply variations of the exact visual characteristics identified in the object. That is, the avatar module 234 may, rather than apply the specific visual characteristics of the object to the base digital avatar 544, apply visual characteristics of the theme that are defined in part by the visual characteristics of the object, which visual characteristics of the theme may be broader than those defined by the visual characteristics of the object. For example, as depicted in FIG. 9, a movie poster 952 may be defined by its visual characteristics and include an image of a cowboy riding a horse while waving his hat and wearing a trenchcoat. The presentation digital avatar 750, by comparison may have a similar theme but with a different type of cowboy hat, a bandanna, and a leather vest that may be consistent with the western theme to which the movie poster 952 is aligned. Note that while particular examples are provided of subject matter and compositional components being transposed from the movie poster 952 to the presentation digital avatar 750, in other examples, other visual characteristics may be transposed to the presentation digital avatar 750.

Note that while FIGS. 8 and 9 specifically depict transposing visual characteristics to the presentation digital avatar 750, other elements consistent with the theme may be transposed to the presentation digital avatar 750. For example, it may be that a particular vocabulary, parlance, accent, etc., may be associated with a particular theme and that a particular form of movement may be associated with a particular theme. In this example, by relying on a deployed generative neural network, the avatar module 234 may construct an auditory theme for the presentation digital avatar 750 based on the defining visual features of the object. That is, the avatar module 234 may deploy a neural network that is trained on a dataset to identify patterns between visual and audio characteristics of digital content. Accordingly, upon receipt of an input that has visual characteristics consistent with a theme, the generative neural network deployed by the avatar module 234 may identify patterns between visual characteristics and audio characteristics associated with that theme and output audio associated with the presentation digital avatar 750 based on the auditory theme. Similarly, upon receipt of an input that has visual characteristics consistent with a theme, the generative neural network deployed by the avatar module 234 may identify movement behaviors and animate the presentation digital avatar 750 consistent with the movement behaviors that the generative neural network has associated with the theme.

At 822 and as described above, the display module 236 may animate the presentation digital avatar 750, with the additional objects transposed thereon, on the display device 748 of the vehicle 100. Accordingly, the present avatar render system 126 provides a user-based customized presentation digital avatar 750 that is uniquely generated based on vehicle-sensor captured data, thereby enabling the real-time incorporation of environmental elements in a moving environment onto an in-vehicle avatar.

FIG. 10 illustrates one embodiment of a neural network-based avatar render system 126 that is associated with generating a presentation digital avatar 750 based on vehicle sensor data according to an embodiment disclosed herein.

In one approach, the avatar render system 126 implements and/or otherwise uses a machine learning algorithm. A machine-learning algorithm generally identifies patterns and deviations based on previously unseen data. In the context of the present application, a machine-learning avatar render system 126 relies on some form of machine learning, whether supervised, unsupervised, reinforcement, or any other type of machine learning, to identify patterns in images and generate an avatar based on such. In the context of the present specification, the neural network-based avatar render system 126 creates new digital avatars that imitate or mimic the visual characteristics of the images it receives. That is, once trained, the neural network generates new digital avatars based on learned patterns in response to an input image.

In one particular example, the machine-learning model may be a neural network that includes any number of 1) input nodes that receive occupant images 1054, object images 1056, and digital content from the corpus 238, 2) hidden nodes, which may be arranged in layers connected to input nodes and/or other hidden nodes and which include computational instructions for computing outputs, and 3) output nodes connected to the hidden nodes which generate a presentation digital avatar 750. Various types of neural networks may be implemented in accordance with the principles described herein, including feedforward neural networks (FNNs), convolutional neural networks (CNNs), recurrent neural networks (RNNs), an artificial neural network (ANN), a deep neural network (DNN), a generative adversarial network (GAN), or a diffusion model. Of course, in further aspects, the avatar module 234 may employ different machine learning algorithms or implement different approaches. Whichever particular approach the avatar module 234 implements, the avatar module 234 provides an output of a presentation digital avatar 750 modified by vehicle-captured images of the surrounding environment. In this way, the avatar render system 126 generates on-the-go environment-influenced digital avatars for an occupant of the vehicle 100.

As depicted in FIG. 10, each layer may include a node that processes input data and generates an output. Nodes on the input layer receive the raw data, which as described above may include occupant images 1054, object images 1056, and corpus 238 images. The nodes in the hidden layer may perform the computations and identify the patterns in the input data. The node in the output layer produces the presentation digital avatar 750, which is presented on the display device 748 of the vehicle 100. The avatar model 230 described above may include the weights, biases, activation functions, and other parameters that guide the learning of the neural network.

During operation, the neural network may perform any number of complex operations such as 1) forward propagation, where the input data is passed through the hidden layers and transformed based on the weights, biases, and activation functions in the avatar model 230 and 2) backpropagation where weights and biases are adjusted based on a loss function or error.

As described above, using a trained or untrained neural network, the avatar module 234 extracts features from the occupant images 1054, object images 1056, and the corpus 238 images. These include different features such as edges, lines, patterns, colors, etc., and visual features such as the theme-defining visual characteristics described above. The nodes in the hidden layer then adjust the images based on the learned patterns while ensuring the preservation of the structure of the occupant features as captured in the occupant image 1054. Iteratively, the avatar render system 126 may compare the developing presentation digital avatar 750 against the occupant image 1054 to ensure content preservation. Moreover, the avatar render system 126 may compare the developing presentation digital avatar 750 against the object image 1056 and corpus 238 to ensure consistency with the theme.

It should be appreciated that machine learning algorithms are generally trained to perform a defined task. Thus, the training of the machine learning algorithm is understood to be distinct from the general use of the machine learning algorithm unless otherwise stated. That is the avatar render system 126 or another system generally trains the machine learning algorithm according to a particular training approach, which may include supervised training, self-supervised training, reinforcement learning, and so on. In contrast to training/learning of the machine learning algorithm, the avatar render system 126 implements the machine learning algorithm to perform inference. Thus, the general use of the machine learning algorithm is described as inference.

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 101. In one or more arrangements, the processor(s) 101 can be a primary/centralized processor of the vehicle 100 or may be representative of many distributed processing units. For instance, the processor(s) 101 can be an electronic control unit (ECU). Alternatively, or additionally, the processors include a central processing unit (CPU), a graphics processing unit (GPU), an ASIC, an microcontroller, a system on a chip (SoC), and/or other electronic processing units that support operation of the vehicle 100.

The vehicle 100 can include one or more data stores 118 for storing one or more types of data. The data store 118 can be comprised of volatile and/or non-volatile memory. Examples of memory that may form the data store 118 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 118 is a component of the processor(s) 101. In general, the data store 118 is operatively connected to the processor(s) 101 for use thereby. The term “operatively connected,” as used throughout this description, can include direct or indirect connections, including connections without direct physical contact.

In one or more arrangements, the one or more data stores 118 include various data elements to support functions of the vehicle 100, such as semi-autonomous and/or autonomous functions. Thus, the data store 118 may store map data 119 and/or sensor data 122. The map data 119 includes, in at least one approach, maps of one or more geographic areas. In some instances, the map data 119 can include information about roads (e.g., lane and/or road maps), traffic control devices, road markings, structures, features, and/or landmarks in the one or more geographic areas. The map data 119 may be characterized, in at least one approach, as a high-definition (HD) map that provides information for autonomous and/or semi-autonomous functions.

In one or more arrangements, the map data 119 can include one or more terrain maps 120. The terrain map(s) 120 can include information about the ground, terrain, roads, surfaces, and/or other features of one or more geographic areas. The terrain map(s) 120 can include elevation data in the one or more geographic areas. In one or more arrangements, the map data 119 includes one or more static obstacle maps 121. The static obstacle map(s) 121 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 122 is data provided from one or more sensors of the sensor system 102. Thus, the sensor data 122 may include observations of a surrounding environment of the vehicle 100 and/or information about the vehicle 100 itself. In some instances, one or more data stores 118 located onboard the vehicle 100 store at least a portion of the map data 119 and/or the sensor data 122. Alternatively, or in addition, at least a portion of the map data 119 and/or the sensor data 122 can be located in one or more data stores 118 that are located remotely from the vehicle 100.

As noted above, the vehicle 100 can include the sensor system 102. The sensor system 102 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 102 and/or the one or more sensors can be operatively connected to the processor(s) 101, the data store(s) 118, and/or another element of the vehicle 100.

Various examples of different types of sensors will be described herein. However, it will be understood that the embodiments are not limited to the particular sensors described. In various configurations, the sensor system 102 includes one or more vehicle sensors 103 and/or one or more environment sensors. The vehicle sensor(s) 103 function to sense information about the vehicle 100 itself. In one or more arrangements, the vehicle sensor(s) 103 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 102 can include one or more environment sensors 104 that sense a surrounding environment (e.g., external) of the vehicle 100 and/or, in at least one arrangement, an environment of a passenger cabin of the vehicle 100. For example, the one or more environment sensors 104 sense objects the surrounding environment of the vehicle 100. Such obstacles may be stationary objects and/or dynamic objects. Various examples of sensors of the sensor system 102 will be described herein. The example sensors may be part of the one or more environment sensors 104 and/or the one or more vehicle sensors 103. However, it will be understood that the embodiments are not limited to the particular sensors described. As an example, in one or more arrangements, the sensor system 102 includes one or more radar sensors 105, one or more LiDAR sensors 106, one or more sonar sensors 107 (e.g., ultrasonic sensors), and/or one or more cameras 108 (e.g., monocular, stereoscopic, RGB, infrared, etc.).

Continuing with the discussion of elements from FIG. 1, the vehicle 100 can include an input system 123. The input system 123 generally encompasses one or more devices that enable the acquisition of information by a machine from an outside source, such as an operator. The input system 123 can receive an input from a vehicle passenger (e.g., a driver/operator and/or a passenger). Additionally, in at least one configuration, the vehicle 100 includes an output system 124. The output system 124 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 109. Various examples of the one or more vehicle systems 109 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 110, a braking system 111, a steering system 112, a throttle system 113, a transmission system 114, a signaling system 115, and a navigation system 116.

The navigation system 116 can include one or more devices, applications, and/or combinations thereof to determine the geographic location of the vehicle 100 and/or to determine a travel route for the vehicle 100. The navigation system 116 can include one or more mapping applications to determine a travel route for the vehicle 100 according to, for example, the map data 119. The navigation system 116 may include or at least provide connection to a global positioning system, a local positioning system or a geolocation system.

In one or more configurations, the vehicle systems 109 function cooperatively with other components of the vehicle 100. For example, the processor(s) 101, the avatar render system 126, and/or automated driving module(s) 125 can be operatively connected to communicate with the various vehicle systems 109 and/or individual components thereof. For example, the processor(s) 101 and/or the automated driving module(s) 125 can be in communication to send and/or receive information from the various vehicle systems 109 to control the navigation and/or maneuvering of the vehicle 100. The processor(s) 101, the avatar render system 126, and/or the automated driving module(s) 125 may control some or all of these vehicle systems 109.

For example, when operating in the autonomous mode, the processor(s) 101 and/or the automated driving module(s) 125 control the heading and speed of the vehicle 100. The processor(s) 101 and/or the automated driving module(s) 125 cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 100 includes one or more actuators 117 in at least one configuration. The actuators 117 are, for example, elements operable to move and/or control a mechanism, such as one or more of the vehicle systems 109 or components thereof responsive to electronic signals or other inputs from the processor(s) 101 and/or the automated driving module(s) 125. The one or more actuators 117 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory computer-readable instructions that, when executed by the processor 101, implement one or more of the various functions described herein. In various arrangements, one or more of the modules are a component of the processor(s) 101, or one or more of the modules are executed on and/or distributed among other processing systems to which the processor(s) 101 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an ASIC, programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 125. The automated driving module(s) 125, in at least one approach, receive data from the sensor system 102 and/or other systems associated with the vehicle 100. In one or more arrangements, the automated driving module(s) 125 use such data to perceive a surrounding environment of the vehicle. The automated driving module(s) 125 determine a position of the vehicle 100 in the surrounding environment and map aspects of the surrounding environment. For example, the automated driving module(s) 125 determines the location of obstacles or other environmental features including traffic signs, trees, shrubs, neighboring vehicles, pedestrians, etc.

The automated driving module(s) 125 can be configured to determine travel path(s), current autonomous driving maneuvers for the vehicle 100, future autonomous driving maneuvers and/or modifications to current autonomous driving maneuvers based on data acquired by the sensor system 102 and/or another source. In general, the automated driving module(s) 125 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-10, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
extract physical characteristics of an occupant of a vehicle from a vehicle-captured image of the occupant;
render a base digital avatar of the occupant based on extracted physical characteristics of the occupant;
extract a feature of an object in an external environment of the vehicle from a vehicle-captured image of the object;
render a presentation digital avatar in a likeness of the occupant by transferring the feature of the object onto the base digital avatar of the occupant; and
animate the presentation digital avatar on a display device of the vehicle.

2. The system of claim 1, wherein the machine-readable instructions further comprise machine-readable instructions that, when executed by the processor, cause the processor to:
detect an action of the occupant that identifies the object and a location of the object; and
retrieve images captured by a vehicle camera with a field of view that overlaps the location of the object.

3. The system of claim 1, wherein the machine-readable instructions further comprise machine-readable instructions that, when executed by the processor, cause the processor to:
determine a level of detail of the feature of the object in the vehicle-captured image;
responsive to the level of detail being below a threshold amount:
identify, from a log of vehicle-captured images, a previously captured image of the object; and
extract the feature of the object from the previously captured image of the object.

4. The system of claim 1, wherein the machine-readable instructions further comprise a machine-readable instruction that, when executed by the processor, causes the processor to deploy a neural network trained to:
receive the vehicle-captured image of the object from a vehicle camera;
extract, from the vehicle-captured image, a distinguishing feature of the object;
identify the object in other images of a corpus of digital content based on the distinguishing feature; and
render a digital model of the object by combining the vehicle-captured image of the object with the other images of the object.

5. The system of claim 4, wherein the machine-readable instruction that causes the processor to deploy the neural network trained comprises a machine-readable instruction that causes the processor to infer features of the object omitted from the vehicle-captured image of the object and the other images of the object.

6. The system of claim 1, wherein:
the machine-readable instructions further comprise machine-readable instructions that, when executed by the processor, cause the processor to deploy a neural network to:
identify defining visual characteristics of the object; and
construct a theme for the presentation digital avatar based on the defining visual characteristics of the object; and
the machine-readable instruction that causes the processor to render the presentation digital avatar in the likeness of the occupant comprises a machine-readable instruction that causes the processor to deploy the neural network to transfer visual characteristics defined by the theme onto the base digital avatar of the occupant.

7. The system of claim 6, wherein the machine-readable instruction that causes the processor to deploy the neural network, comprises a machine-readable instruction that causes the processor to deploy the neural network to:
identify other images in a corpus of digital content that have same or similar defining visual characteristics as the object; and
aggregate defining visual characteristics of the object and the other images to construct the theme.

8. The system of claim 6, wherein the machine-readable instruction that causes the processor to deploy the neural network, comprises a machine-readable instruction that causes the processor to deploy the neural network to:
construct an auditory theme for the presentation digital avatar based on the defining visual characteristics of the object; and
output audio associated with the presentation digital avatar based on the auditory theme.

9. A non-transitory machine-readable medium comprising instructions that, when executed by a processor, cause the processor to:
extract physical characteristics of an occupant of a vehicle from a vehicle-captured image of the occupant;
render a base digital avatar of the occupant based on extracted physical characteristics of the occupant;
extract a feature of an object in an external environment of the vehicle from a vehicle-captured image of the object;
render a presentation digital avatar in a likeness of the occupant by transferring the feature of the object onto the base digital avatar of the occupant; and
animate the presentation digital avatar on a display device of the vehicle.

10. The non-transitory machine-readable medium of claim 9, wherein the machine-readable medium further comprises instructions that, when executed by the processor, cause the processor to:
detect an action of the occupant that identifies the object and a location of the object; and
retrieve images captured by a vehicle camera with a field of view that overlaps the location of the object.

11. The non-transitory machine-readable medium of claim 9, wherein the machine-readable medium further comprises instructions that, when executed by the processor, cause the processor to:
determine a level of detail of the feature of the object in the vehicle-captured image;
responsive to the level of detail being below a threshold amount:
identify, from a log of vehicle-captured images, a previously captured image of the object; and
extract the feature of the object from the previously captured image of the object.

12. The non-transitory machine-readable medium of claim 9, wherein the machine-readable medium further comprises an instruction that, when executed by the processor, causes the processor to deploy a neural network trained to:
receive the vehicle-captured image of the object from a vehicle camera;
extract, from the vehicle-captured image, a distinguishing feature of the object;
identify the object in other images of a corpus of digital content based on the distinguishing feature; and
render a digital model of the object by combining the vehicle-captured image of the object with the other images of the object.

13. The non-transitory machine-readable medium of claim 9, wherein:
the machine-readable medium further comprises an instruction that, when executed by the processor, causes the processor to deploy a neural network to:
identify defining visual characteristics of the object; and
construct a theme for the presentation digital avatar based on the defining visual characteristics of the object; and
the instruction that causes the processor to render the presentation digital avatar in the likeness of the occupant comprises an instruction that causes the processor to deploy the neural network to transfer visual characteristics defined by the theme onto the base digital avatar of the occupant.

14. The non-transitory machine-readable medium of claim 13, wherein the instruction that causes the processor to deploy the neural network, comprises an instruction that causes the processor to deploy the neural network to:
identify other images in a corpus of digital content that have same or similar defining visual characteristics as the object; and
aggregate defining visual characteristics of the object and the other images to construct the theme.

15. A method, comprising:
extracting physical characteristics of an occupant of a vehicle from a vehicle-captured image of the occupant;
rendering a base digital avatar of the occupant based on extracted physical characteristics of the occupant;
extracting a feature of an object in an external environment of the vehicle from a vehicle-captured image of the object;
rendering a presentation digital avatar in a likeness of the occupant by transferring the feature of the object onto the base digital avatar of the occupant; and
animating the presentation digital avatar on a display device of the vehicle.

16. The method of claim 15, further comprising:
detecting an action of the occupant that identifies the object and a location of the object; and
retrieving images captured by a vehicle camera with a field of view that overlaps the location of the object.

17. The method of claim 15, further comprising:
determining a level of detail of the feature of the object in the vehicle-captured image;
responsive to the level of detail being below a threshold amount:
identifying, from a log of vehicle-captured images, a previously captured image of the object; and
extracting the feature of the object from the previously captured image of the object.

18. The method of claim 15, further comprising deploying a neural network to:
receive the vehicle-captured image of the object from a vehicle camera;
extract, from the vehicle-captured image, a distinguishing feature of the object;
identify the object in other images of a corpus of digital content based on the distinguishing feature; and
render a digital model of the object by combining the vehicle-captured image of the object with the other images of the object.

19. The method of claim 15, wherein:
the method further comprises deploying a neural network to:
identify defining visual characteristics of the object; and
construct a theme for the presentation digital avatar based on the defining visual characteristics of the object; and
rendering the presentation digital avatar in the likeness of the occupant comprises deploying the neural network to transfer visual characteristics defined by the theme onto the base digital avatar of the occupant.

20. The method of claim 19, wherein deploying the neural network, further comprises deploying the neural network to:
identify other images in a corpus of digital content that have same or similar defining visual characteristics as the object; and
aggregate the defining visual characteristics of the object and the other images to construct the theme.
